(19) United States
(12) Patent Application Publication
(10) Pub. No.: US 2025/0001516 A1
(43) Pub. Date: Jan. 2, 2025

(54) Solid State Fusion Wire Additive Manufacturing

(71) Applicant: Lunar Resources Inc., Houston, TX (US)

(72) Inventor: Sumontro Sinha, Houston, TX (US)

(73) Assignee: Lunar Resources Inc., Houston, TX (US)

(21) Appl. No.: 18/754,566

(22) Filed: Jun. 26, 2024

Related U.S. Application Data
(60) Provisional application No. 63/523,441, filed on Jun. 27, 2023.

(51) Int. Cl. B23K 10/02; B23K 10/00; B33Y 10/00; B33Y 30/00; B33Y 40/10

(52) U.S. Cl. CPC B23K 10/027; B23K 10/006; B33Y 10/00; B33Y 30/00; B33Y 40/10

(57) ABSTRACT

Systems and methods for additive manufacturing are provided. A system for additive manufacturing may include a feedstock shaping system for shaping an elongated metal-containing feedstock; a force applicator for applying force to the elongated metal-containing feedstock; a print head for passing a pulsed electric current through the elongated metal-containing feedstock and a substratum; and a power supply associated with the print head for sending pulsed power to the print head.

### BACKGROUND

Additive manufacturing processes have revolutionized the way complex parts are designed and manufactured. In general, additive manufacturing processes refer to processes that build three-dimensional objects layer by layer. Most additive manufacturing processes generally rely on melting or sintering a feedstock material to join successive layers of material into a single bulk part. This can result in both the requirement for significant post-processing for final shape as well as the possibility of inferior part properties.

### SUMMARY

Disclosed herein is an example system for additive manufacturing comprising: feedstock shaping system for shaping an elongated metal-containing feedstock; a force applicator for applying force to the elongated metal-containing feedstock; a print head for passing a pulsed electric current through the elongated metal-containing feedstock and a substratum; and a power supply associated with the print head for sending pulsed power to the print head.

Further disclosed herein is an example method for additive manufacturing comprising: feeding an elongated metal-containing feedstock to a print head; shaping the elongated metal-containing feedstock in accordance with a digital model of an assembled structure; applying pressure to press the elongated metal-containing feedstock to a substratum; sending energy to the print head such that an electric current passes between the elongated metal-containing feedstock and the substratum; and joining the elongated metal-containing feedstock and the substratum.

It is to be understood that both the foregoing general description and the following detailed description are exemplary and explanatory in nature and are intended to provide an understanding of the present disclosure without limiting the scope of the present disclosure. In that regard, additional aspects, features, and advantages of the present disclosure will be apparent to one skilled in the art from the following detailed description.

### BRIEF DESCRIPTION OF THE DRAWINGS

These drawings illustrate certain aspects of some of the embodiments of the present invention and should not be used to limit or define the invention.

FIG. 1 is a schematic diagram showing a system for additive manufacturing in accordance with embodiments of the present disclosure.

FIG. 2 is another schematic diagram showing a process for manufacturing an assembled structure in accordance with embodiments of the present disclosure.

FIG. 3 is a close-up side view of a print head in a process for manufacturing an assembled structure in accordance with embodiments of the present disclosure.

FIGS. 4A-4F are schematic diagrams showing a process for manufacturing an assembled structure in accordance with embodiments of the present disclosure.

FIG. 5 is an assembled structure in accordance with embodiments of the present disclosure.

FIG. 6 is another assembled structured in accordance with embodiments of the present disclosure.

FIG. 7 is a schematic diagram showing another system for additive manufacturing in accordance with embodiments of the present disclosure.

### DETAILED DESCRIPTION

It is to be understood that the present disclosure is not limited to particular devices or methods, which may, of course, vary. It is also to be understood that the terminology used herein is for the purpose of describing particular embodiments only and is not intended to be limiting. All numbers and ranges disclosed herein may vary by some amount. Whenever a numerical range with a lower limit and an upper limit is disclosed, any number and any included range falling within the range are specifically disclosed. Although individual embodiments are discussed herein, the invention covers all combinations of all those embodiments. As used herein, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected. If there is any conflict in the usages of a word or term in this specification and one or more patent or other documents that may be incorporated herein by reference, the definitions that are consistent with this specification should be adopted for the purposes of understanding this invention.

Disclosed herein are systems and methods for additive manufacturing and, more particularly, disclosed are systems and methods for additive manufacturing that join an elongated metal-containing feedstock to a substratum through a solid-state joining process that uses high power, high voltage, short duration energy pulses to join the metal feedstock. The process is considered “solid state” because the elongated metal-containing substratum is not fully melted through its entire cross-section or, to the extent that melting may occur. Rather, only localized melting occurs at the joint with no more than 50% of the cross-section being melted. In some embodiments, the energy pulses may be used to clean the metal feedstock, for example, remove oxides, prior to solid state joining.

Most additive manufacturing processes generally rely on sintering or fully melting the bulk feedstock to join successive layers of material to the preceding layer resulting in inferior part properties, especially for metals. By changing the bulk feedstock from a solid to a different phase, form or crystal structure (e.g., liquid or sintered) and back to a solid, there are many challenges, especially for metals and alloys, such as steel, stainless steel, copper, invar, titanium, aluminum, tungsten, molybdenum, nickel, zinc, tantalum, magnesium, gold, silver, niobium, Inconel, cobalt, Hastelloy, Waspaloy, hafnium, osmium, vanadium, palladium, yttrium, platinum group metals, other refractory metals, uranium, plutonium, thorium, lead, beryllium, tin, silicon, zirconium, antimony, rare earth elements, indium, manganese, rhenium, ruthenium, cadmium, palladium, gallium, chromium, bismuth, as well as alloys comprising one or more of these metals. While additive manufacturing can generate bulk structures by sintering or melting metals either by wire feedstock methods or powder feedstock methods, there are a number of drawbacks and challenges.

The typical challenges of additive manufacturing include, but are not limited to, microstructure quality, surface roughness and thickness, residual stress, part distortion, deposition rates, and variation of part strength. For example, additive manufacturing can have poor material quality such as microstructure porosity and defects caused by uncontrolled solidification. In addition, the part geometry may have poor tolerances due to uncontrolled buildup of residual stress caused by thermal gradients and rapid cooling. Further, depositions rates to produce a part may be significantly slower than traditional manufacturing approaches (forging, casting, machining). For metal feedstocks, poor surface roughness and variable thickness can be caused by metals “pooling” in beads when they are melted, which are then deposited onto the build surface and immediately solidify. When they solidify, they create irregularly shaped protuberances, which impact the structure thickness and surface roughness of the part. Even further, residual heat can build up when performing additive manufacturing of high temperature materials, such as metals, resulting in unpredictable solidification dynamics in the part being built, which can create warping of the assembled structure and print bed.

These and other problems have plagued additive manufacturing, especially additive manufacturing of metals. Current approaches to overcoming these issues have recently focused on developing software integration with sensors to actively control the additive manufacturing process. Even with this new software, assembled structures still need significant post processing to obtain functional net shape parts.

The systems and methods for additive manufacturing disclosed herein can be used to enable solid-state joining of an elongated metal-containing feedstock with a substratum. The systems and methods may be used with a wide variety of elongated metal-containing feedstocks, including, but not limited to metals, metal ceramics, or other materials containing metal. For example, the elongated metal-containing feedstocks may include a wide variety of metals and alloys, such as steel, stainless steel, copper, invar, titanium, aluminum, tungsten, molybdenum, nickel, zinc, tantalum, magnesium, gold, silver, niobium, Inconel, cobalt, Hastelloy, Waspaloy, hafnium, osmium, vanadium, palladium, yttrium, platinum group metals, other refractory metals, uranium, plutonium, thorium, lead, beryllium, tin, silicon, zirconium, antimony, rare earth elements, indium, manganese, rhenium, ruthenium, cadmium, palladium, gallium, chromium, bismuth, as well as alloys comprising one or more of these materials.

Example embodiments of the method for the additive manufacturing system may include feeding an elongated metal-containing feedstock to a print head. The elongated metal-containing feedstock may further be shaped, for example, in accordance with a digital model of an assembled structure by a bending machine or other suitable feedstock shaping system. The elongated metal-containing feedstock may be shaped into a wide variety of shapes through a feedstock shaping system, for example, that performs bending or slicing. To facilitate joining, a force applicator may apply pressure to the elongated metal-containing feedstock to force it to contact a substratum. With the elongated metal-containing feedstock pressed to the substratum, pulsed power from a power supply may be sent to the print head electrodes such that high voltage electric pulse pass between the elongated metal-containing feedstock and the substratum to generate heat from resistance to pulse current flow. In accordance with some embodiments, the power is pulsed to heat and join the elongated metal-containing feedstock to the substratum by a solid-state joint, resistance welded joint or wire bonding joint. For example, the pulsed power can pulse DC current to a print head that joins metals by heating obtained from resistance to electric current. By way of further example, pulsed power can melt a specialized welding node to join metals, for example, by its ability to produce a plasma in vacuum. In some embodiments, the pulsed power may be used to clean an exterior of the elongated metal-containing feedstock. For example, the pulsed power may generate a plasma that at least partially ablates an oxide layer, exposing bare metal. Following cleaning, the elongated metal-containing feedstock and the substratum may be joined by application of pressure. The elongated metal-containing feedstock may be cut as part of or separate to the bending machine to form a single layer of the elongated metal-containing feedstock bonded to the substratum. Additional portions of the elongated metal-containing feedstock may then be positioned and sequentially joined to the substratum to add additional layers to form an assembled structure. The additional portions may be placed, for example, above, below and/or on the side of the previous layer. In this manner, multiple layers may be added to build a more complex structure.

Example embodiments of the method for additive manufacturing may use a pulsed power supply. The pulses may be high voltage, high current or low voltage, high current and thus be high-energy pulses. In addition, the pulsed power supply can deliver power with a range of discharge times enabling localized heating, softening, and/or melting to tailor material properties. Pulsed power also has greater electrical power efficiencies compared to traditional directed energy deposition processes like laser and electron beam. The power may be pulsed, for example, in an amount of about 1 millijoule to about 1 megajoule and at a frequency of about 1 millihertz to about 1 megahertz. In particular embodiments, the power may be pulsed in an amount of about 1 millijoules to 1 megajoules and at a discharge time range of about 1 nanosecond to 1 second. Any suitable technique may be used to provide pulsed power. Examples of suitable power supplies may include linear transformer drivers, Marx generators, capacitive discharge, inductive discharge, tesla coils, Blumlein pulse forming networks, pulse transformers, transverse electromagnetic mode cell, magnetic pulse compression, vector inversion spiral generators, explosively driven pulsed power systems, compact magnetic pulse compression systems, capacitor banks, and transmission line transformers. In some embodiments, pulsed power may be provided with a spiral generator. For example, a DC power supply may be connected to a vector inversion spiral generator to provide the pulsed power.

Example embodiments of the method for additive manufacturing may use a motion control platform to guide the pulsed power print head. The motion control platform may be a machine that moves the print head to join the elongated feedstock to the substratum at various points. Or the motion control platform may be a machine where the platform moves the substratum to the print head. By controlling the placement and spacing of the joints, the pulsed power system can build an assembled structure with a high degree of accuracy and precision reducing post processing, and potentially reducing or even eliminating thermal distortion normally associated with additive manufacturing. In addition, the elongated metal-containing feedstock can be multiple cross-section shaped wire and different wire sizes which can be used simultaneously or in sequence to optimize production time and/or improved surface finish while building a part. The motion control platform may be linked to a custom stacking algorithm with a digital model of the assembled structure to enable repeated production of small to large structures with known shapes and mechanical properties. Embodiments of the motion control platform may include a multi-axis motion control platform. The motion control platform may include, for example, an arm that can support and move the print head. In some embodiments, the motion control platform includes an articulating arm. In some embodiments, the motion control platform includes a gantry system that can provide positioning along 2- or 3-perpendicular axes of motion. The gantry system can include a carriage that holds and supports the print head. In some embodiments, the print bed can also provide positioning in addition to, or in place of, the motion control platform. For example, the print head can move in one or more directions including but not limited to linear and rotary motion. Alternatively, in some embodiments, the motion control platform includes the substratum moving with the print head fixed, such as rotating the substratum or tilting the substratum to build a part. Alternatively, in some embodiments, the motion control platform includes the substratum fixed with the print head 250 fixed, with the elongated metal-containing feedstock being shaped and joined into a part.

It is believed that the example embodiments disclosed herein can produce assembled structures from elongated metal-containing feedstock with a number of advantages. For example, because the process localizes in time and space the delivery of energy for the joining there is no significant microstructure change in the metal-containing feedstock with only limited resulting change in crystal structure of the elongated metal-containing feedstock. In addition, because example embodiments employ pulsed power, there may only be minimal heat buildup in the assembled structure, thus reducing and even potentially eliminating warping. This may be particularly beneficial to enable assembly of thin-walled structures (e.g., thickness of <0.3 cm), which would otherwise be problematic with conventional techniques due, for example, to warping, among other challenges.

It is believed that the example embodiments disclosed herein may also be able to assemble a wide variety of structures that would otherwise be problematic to achieve with additive manufacturing. For example, the methods and systems may enable the assembly of thin-walled structures, such as scramjet intakes, rocket fairings, fuselages, horizontal stabilizers, and heat exchangers. In addition, the pulsed method and systems may enable the assembly of parts, components, or structures which are traditionally produced by machining, forging or casting techniques such as turbine blades as example aircraft turbine blades. By enabling additive manufacturing with a wide variety of metals and metal alloys the example embodiments may be used to assemble aircraft turbine blades from advanced superalloys materials, such as titanium aluminide. By way of further example, the pulsed power methods and systems example embodiments enable the additive manufacturing of metals, such as uranium that may be used to assemble nuclear fission fuel, such as fuel rods and fuel bundles in a variety of configurations as example, lattice structures. Moreover, the methods and systems may enable the assembly of rocket engine nozzles. By enabling additive manufacturing of metals, such as tungsten and tungsten alloys, embodiments may be used to assemble rocket engine nozzles. By enabling additive manufacturing of metals, such as stainless steel, embodiments may be used to assemble large metallic structures such as engine blocks or other large structures.

In some embodiments, the pulsed power additive manufacturing system and pulsed power methods may be employed in a space environment. The term “space environment” refers to the region outside Earth's atmosphere (i.e., greater than 100 kilometers above Earth's surface). Space environments include the following environments: free space; low earth orbit (“LEO”); sun-synchronous orbit (“SSO”); medium earth orbit (“MEO”); geostationary, or geosynchronous, orbit (“GEO”); other earth orbits; and cis-lunar space, as well as on the surface and below the surface of the Earth's moon, or other planetary bodies, including Moons, having reduced atmospheres, such as other moons, asteroids, and other planets, e.g., Mercury, Mars, etc. In some embodiments, the methods and systems may be employed in a space environment with a vacuum. In some embodiments, the methods and systems may be employed in a space environment with microgravity, i.e., environments with a very small force of gravity such that people or objects appear to be weightless and float.

The pulsed power additive manufacturing system and pulsed power methods may take advantage of the reduced force of gravity and natural vacuum in a space environment, for example, where other joining techniques such as arc welding require adaptation for use. For example, arc welding and gas tungsten arc welding require an atmosphere to generate and maintain the plasma that supports the joining process. The space environment presents a challenge to these techniques since there may be no atmospheric species that can be used to generate plasma. In addition, in traditional metal additive manufacturing the melted or molten metal requires a force exerted onto the melted feedstock, such as gravity, to place the molten metal-containing feedstock onto a build surface. The space environment presents a challenge to these techniques since there may be reduced or microgravity. In contrast, by use of pulsed power with resultant high voltage, sufficient heat can be generated in a space environment to join metal-containing feedstocks without the need of gravity or atmosphere. Alternatively, the use of pulsed power with resultant high voltage can produce a plasma from the materials of either the substratum, the elongated metal-containing feedstock or electrodes. In the pulsed power process the high-energy pulses can vaporize and clean off any surface oxides from the substratum or feedstock to enable bonding. After oxides are cleaned from the surface with the generated plasma, feedstock can be joined to another material, for example, by application of pressure.

In addition, example embodiments may be particularly beneficial in a space environment where available power may be limited. Typical joining techniques such as electron beam and laser welding require up to 1 kW or more of electrical wall power, which is a large amount in terms of current space power capabilities. Thus, in space environments with limited power availability techniques such as e-beam or laser welding may not be useful. However, example embodiments utilizing pulsed power can more efficiently couple energy to the work piece resulting in significantly lower power use than other bonding methods. In particular embodiments, pulsed power may be used to efficiently convert electrical energy to heat through a capacitive discharge process which isolates the joining process from the power source. Because capacitors have a much lower series resistance than voltage reduction transformers and power filtering elements that are used in conventional techniques, pulsed power can provide high voltage energy which couples more efficiently with the build product.

In addition to space environments, the pulsed power additive manufacturing system and pulsed power methods may also be used in the Earth's atmosphere. Even further, the methods and systems may be performed in an enclosure with an inert atmosphere such as argon, neon, xenon, krypton, helium, carbon dioxide or nitrogen. By use in an inert atmosphere, oxidation challenges are reduced. Furthermore, by use of pulsed power with resultant high voltage to produce a plasma, oxides may be vaporized and cleaned from a feedstock to enable bonding in a vacuum or inert atmosphere on Earth. After oxides are cleaned from the surface with the generated plasma, feedstock can be joined to another material, for example, by application of pressure.

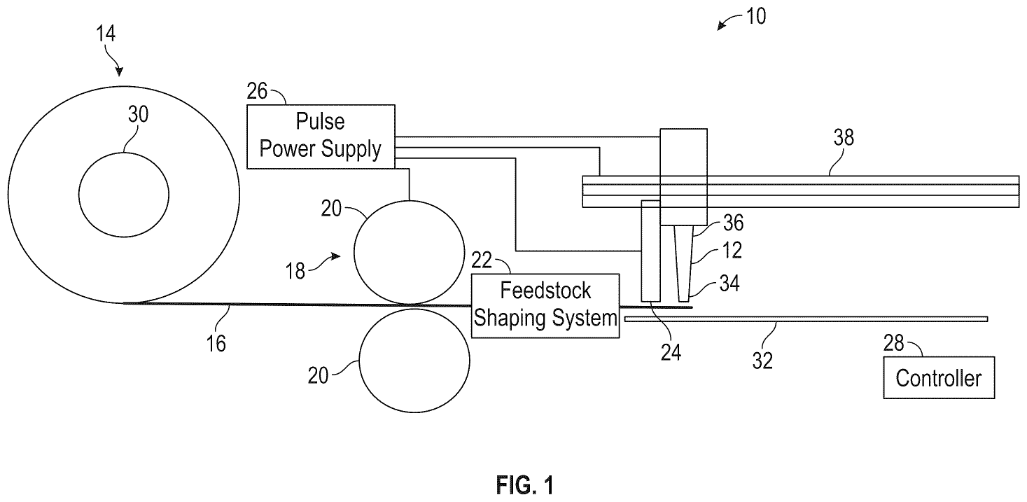

FIG. 1 illustrates a system 10 for pulsed power additive manufacturing in accordance with one or more embodiments. As illustrated, the system 10 includes a print head 12 and a feed system 14 including an elongated metal-containing feedstock 16, feed drive mechanism 18 (e.g., feed rollers 20), feedstock shaping system 22, and a cutter 24. The feed system 14 feeds the elongated metal-containing feedstock 16 to a print head 12. The print head 12 receives power from a pulsed power supply 26 to additively manufacture an assembled structure (not separately shown) from the elongated metal-containing feedstock 16. The system 10 also includes a controller 28 that controls the print head 12 and the pulsed power supply 26.

The feed system 14 includes an elongated metal-containing feedstock 16. The elongated metal-containing feedstock 16 may be positioned on a spool 30 or other suitable mechanism for dispensing the elongated metal-containing feedstock 16. The elongated metal-containing feedstock 16 may include any of a variety of metal-containing feedstocks. For example, the elongated metal-containing feedstock 16 may include a wide variety of metals, such as steel, stainless steel, copper, invar, titanium, aluminum, tungsten, molybdenum, nickel, zinc, tantalum, magnesium, gold, silver, niobium, Inconel, cobalt, Hastelloy, Waspaloy, hafnium, osmium, vanadium, palladium, yttrium, platinum group metals, other refractory metals, uranium, plutonium, thorium, lead, beryllium, tin, silicon, zirconium, antimony, rare earth elements, indium, manganese, rhenium, ruthenium, cadmium, palladium, chromium, bismuth, as well as alloys comprising one or more of these materials. The elongated metal-containing feedstock 16 is referred to as being elongated because it is longer than it is wide, i.e., having a length to width ratio of 10, 50, 100, 500, 1000, or even greater. For example, the elongated metal-containing feedstock 16 can include wire (e.g., metal wire) that can have lengths tens of meters or longer with widths of about 50 millimeters, about 20 millimeters, about 10 millimeters, about 5 millimeters, or even smaller. In some embodiments, the elongated metal-containing feedstock 16 includes wire having a cross-sectional area of about 2,500 square millimeters (mm²) or less, for example, about 1000 mm², about 500 mm², about 100 mm², or less. In some embodiments, the elongated metal-containing feedstock 16 includes wire having a circular, square, hexagonal, ribbon, half-round, triangle or rectangular or other geometric-shaped cross-section which may include secondary features such as guide grooves, divots, locating protrusions or depressions.

The elongated metal-containing feedstock 16 have multiple different cross-sections and/or different sizes. The different cross-sections and/or different sizes may be used simultaneously or sequentially. For example, a portion of a part may be assembled using elongated metal-containing feedstock 16 then additional elongated metal-containing feed stock having a different cross-section may be used to build another portion of the part. By way of further example, feedstocks having different cross-sections may be used simultaneously to assemble a portion of the part Similarly, feedstocks having different sizes may also be used to assemble the part. In some embodiments, elongated metal-containing feedstock 16s may have different cross-sections and different sizes. Advantageously, selection of the elongated metal-containing feedstock 16 cross-section and size may be used to optimize production time and/or improve surface finish. For example, a small cross section ribbon shaped wire can be used to produce a perimeter layer of a build part which can then be filled in with large square cross section wire to produce a part more rapidly. By way of further example, a cylindrical cross section wire can be used to produce a build part and a smaller cross section triangular wire can be used to fill in the gaps between the cylindrical wire.

The feed system 14 further includes a feed drive mechanism 18. The feed drive mechanism 18 may function, for example, to pull the elongated metal-containing feedstock 16 and move it to the print head 12 and/or downstream devices such as the feedstock shaping system 22. The feed drive mechanism 18 may further function to hold the elongated metal-containing feedstock 16 while joining is being done. In the illustrated embodiment of FIG. 1, the feed drive mechanism 18 comprises a pair of feed rollers 20. However, other suitable devices that can hold the elongated metal-containing feedstock 16 and also move it to the print head 12 or feedstock shaping system 22 may also be suitable for use. Examples of other suitable devices may include chains, belts, and ratchet mechanisms, among others.

The feed system 14 further includes a cutter 24. The cutter 24 may function for example, to cut the elongated metal-containing feedstock 16. The elongated metal-containing feedstock 16 may be cut, for example, before or after elongated metal-containing feedstock 16 has been joined to the substratum. By cutting the elongated metal-containing feedstock 16, an additional portion of the feedstock can be supplied to the print head 12 for additive manufacture. Any suitable cutter 24 may be used. Examples of suitable cutters may include a cutting blade, plasma arc, saw, ultrasonic blade, drill, milling bit, or wire electro discharge system.

The feed system 14 may include one or more additional components. For example, the feed system 14 may include a feedstock shaping system 22 such as a wire bending system. The feedstock shaping system 22 may function to bend the elongated metal-containing feedstock 16. In some embodiments, the feedstock shaping system bends the elongated metal-containing feedstock 16 in accordance with a digital model of the assembled structure. Accordingly, repeated steps of bending the elongated metal-containing feedstock 16 and joining the elongated metal-containing feedstock 16 to a substratum can result in forming layers of an assembled structure. An example of a suitable feedstock shaping system 22 includes a CNC wire bender. In further embodiments, the feedstock shaping system 22 may include a wire straightener. For example, the wire straightener may be positioned upstream of the bending machine and the feed drive mechanism 18 to straighten the elongated metal-containing feedstock 16 as it is received from the spool 30. In some embodiments, the wire straightener may include a series of rollers that form a passageway therethrough, straightening the elongated metal-containing feedstock 16 as it is pulled through the passageway.

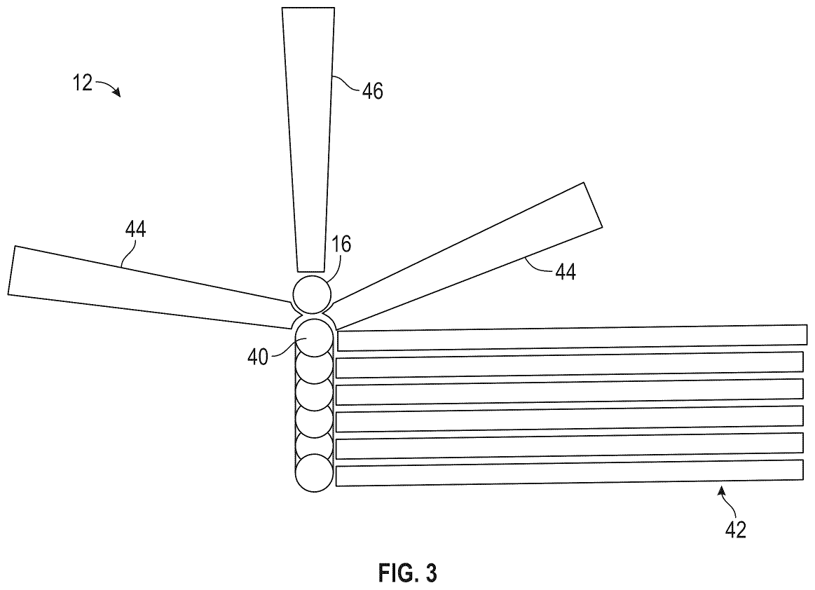

As previously mentioned, the feed system 14 supplies the elongated metal-containing feedstock 16 to a print head 12. The print head 12 passes electric high energy pulses through the elongated metal-containing feedstock 16 and the substratum to generate heat at their interface. In some embodiments, the energy pulses remove oxide(s) from the metal surface. A force applicator (e.g., force applicator 46 shown on FIG. 3) may further be included in the system 10 to press the elongated metal-containing feedstock 16 to the substratum, which may be, for example, a print bed 32 or a previously placed portion of the elongated metal-containing feedstock 16. By passing high energy pulses through the elongated metal-containing feedstock 16 and the substratum (e.g., print bed 32), they may be joined to one another. For example, spot welds, solid state joints, or wire bonds may be formed to join the elongated metal-containing feedstock 16 and the substratum. In some embodiments, the energy pulses remove oxide(s) from the metal surface with solid-state joining performed, for example, by application of pressure. In some embodiments, the print head 12 includes one or more electrodes (e.g., electrodes 44 shown on FIG. 3) through which the electric high energy pulses generate current which passes from the print head 12 to the elongated metal-containing feedstock 16 and the substratum. The electrodes may each individually be placed into contact with the elongated metal-containing feedstock 16, the substratum, or both for current passage.

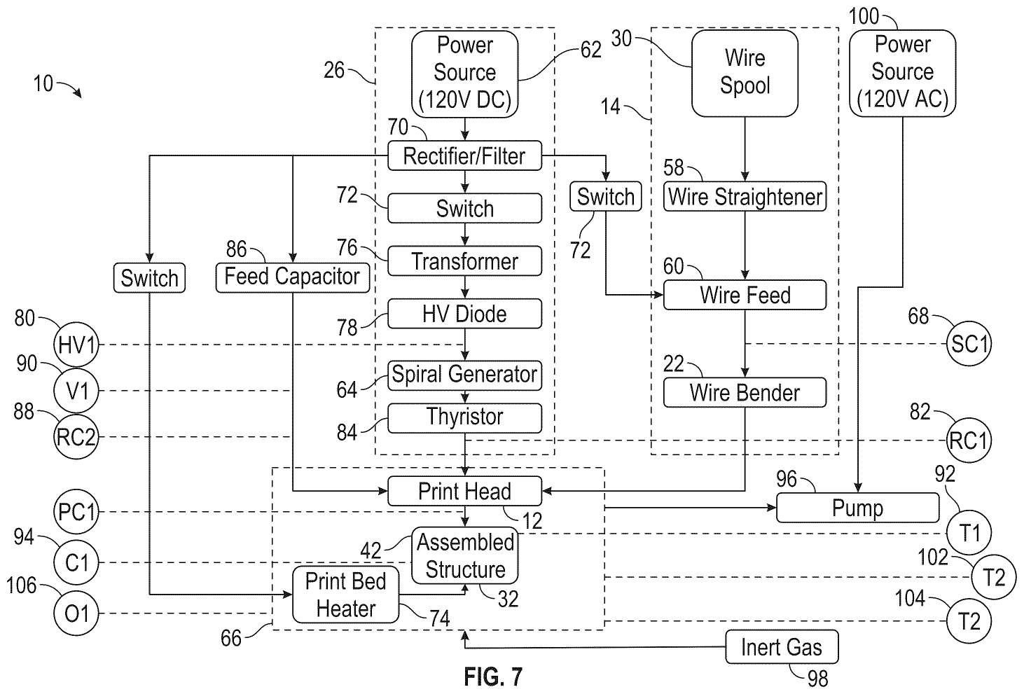

The print head 12 may join the elongated metal-containing feedstock 16 to a substratum, such as the print bed 32, build plate or build rod. In other embodiments, the substratum may be another portion of the elongated metal-containing feedstock 16 that was previously placed to from an assembled structure. The print bed 32 may include a plate, rod or other suitable support structure for supporting the assembled structure as it is being assembled. In some embodiments, the print bed 32 can be moved, for example, in 1-, 2-, or 3-perpendicular axis of motion. In other embodiments, the print head 12 remains stationary, for example, to maintain the structure in position during assembly. In some embodiments, both the print bed 32 and the print head 12 may move. In some embodiments, the system may further include a print bed heater (e.g., heater ** shown on FIG. 7) for heating the print bed 32 or a cooler for cooling the print bed.

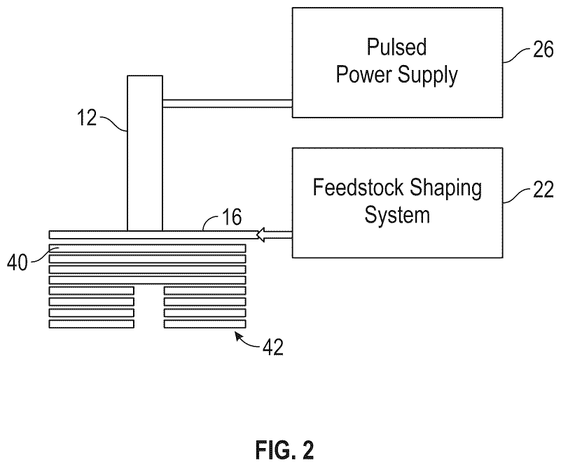

The print head 12 may include a first end 34 and second end 36. One or more electrodes (e.g., electrodes 44 shown on FIG. 2) may be disposed at the first end 34. The second end 36 of the print head 12 may be coupled to a motion control platform 38 or other suitable support structure that supports the print head 12. In some embodiments, a carriage secures the print head 12 to the motion control platform 38. The motion control platform 38 may be a robotic arm, for example. In other embodiments, the motion control platform 38 may be a component of a gantry system, delta system, scara system, polar system, H-bot system and CoreXY system, for example, that can provide positioning along 1-,2- or 3-perpendicular axes of motion. The motion control platform 38, whether a gantry system, robotic arm, or other suitable motion system, can move the print head 12 or substratum in a 1-, 2- or 3-dimensional space, for example, to precisely join the elongated metal-containing feedstock 16 to a substratum during assembly. In some embodiments, the print head 12 may remain stationary while the print bed 32 (or other support structure for the print bed 32) moves. In some embodiments, both the print head 12 and the print bed 32 may be configured for movement.

The print head 12 may receive power from a pulsed power supply 26. The print head 12 may be electrically coupled to the pulsed power supply 26. The power may be pulsed, for example, in an amount of about 1 millijoule to about 1 megajoule and at a frequency of about 1 millihertz to about 1 megahertz. In particular embodiments, the power may be pulsed in an amount of about 1 millijoules to about 1 kilojoule and at a discharge time range of about 1 nanosecond to 1 second. Any suitable technique may be used to provide pulsed power. Examples of suitable pulsed power supplies may include linear transformer drivers, Marx generators, capacitive discharge, inductive discharge, tesla coils, Blumlein pulse forming networks, pulse transformers, vector inversion spiral generators, transverse electromagnetic mode cell, magnetic pulse compression systems, explosively driven pulsed power systems, compact magnetic pulse compression systems, capacitor banks, transmission line transformers. In some embodiments, pulsed power may be provided with a spiral generator. In some embodiments, the spiral generator may be a vector inversion spiral generator comprising a rolled-up strip transmission line with an additional insulating layer or high relative permittivity dielectric layer between turns. As used herein, high relative permittivity is from 1 million to 2 million In some embodiments, a DC power supply may be connected to a vector inversion spiral generator to provide the pulsed power.

The system 10 for pulsed power additive manufacturing may further include a controller 28. The controller 28 may be communicatively coupled to one or more of the pulsed power supply 26, the feedstock shaping system 22, the print head 12, motion control platform 38, and/or the cutter 24. The connection between these components may be a wired or wireless connection, as desired for a particular application. The controller 28 may include a processor or other suitable device for processing instructions. For example, the controller may include a programable logic circuit, microprocessor, microcontroller, embedded microcontroller, programmable digital signal processor, or other programmable device. The controller 28 may also, or instead, be embodied in an application specific integrated circuit, a programmable gate array, programmable array logic, or any other device or combinations of devices operable to process electric signals.

The controller 28 may provide instructions to the pulsed power supply 26, the feedstock shaping system 22, motion control platform 38, the print head 12, and the cutter 24. For example, the controller 28 may send instructions to the pulsed power supply 26 to supply pulsed power to the print head 12. By way of further example, the controller 28 may send bending instructions to feedstock shaping system 22 for shaping the elongated metal-containing feedstock 16 in accordance with a digital model of the assembled structure. By way of further example, the controller 28 may send position instructions to the motion control platform 38 (or other suitable motion control device) for positioning the print head 12 to fabricate the assembled structure in accordance with the digital model.

FIG. 2 is a schematic diagram illustrating a process for additive manufacturing in accordance with one or more embodiments. As illustrated, an elongated metal-containing feedstock 16 may be fed from a feedstock shaping system to a print head 12. A pulsed power supply 26 may provide power (e.g., pulsed power) to the print head 12. The print head 12 may then pass resultant electric current through the elongated metal-containing feedstock 16 and a substratum 40. In the illustrated embodiment of FIG. 2, a prior layer of the elongated metal-containing feedstock 16 is the substratum 40. The print head 12 (or other force applicator) may also apply force to the elongated metal-containing feedstock 16 to press it to the substratum 40. As the electric current is passed through the elongated metal-containing feedstock 16 and the substratum 40, heat is generated from resistance to current flow resulting in joining through the formation of a spot weld, solid state joint or wire bond to join of the elongated metal-containing feedstock 16 and the substratum 40, which in this instance is a preceding layer of the elongated metal-containing feedstock 16. While the spot welds, solid state joints or wire bonds are not shown on this figure, multiple layers of the elongated metal-containing feedstock 16 are illustrated in FIG. 2 that have been joined in accordance with example pulsed power embodiments to form the assembled structure 42.

FIG. 3 is a schematic diagram illustrating a process for additive manufacturing in accordance with one or more pulsed power embodiments. FIG. 3 illustrates formation of an assembled structure 42 through joining of an elongated metal-containing feedstock 16 to successive layers of the elongated metal-containing feedstock 16 which form the substratum 40. As illustrated in FIG. 3, the print head 12 may be used to join a portion of the elongated metal-containing feedstock 16 to a substratum 40, which in this instance is a preceding layer of the elongated metal-containing feedstock 16. The electrodes 44 of the print head 12 may engage both the elongated metal-containing feedstock 16 and the substratum 40. A force applicator 46 may also engage the elongated metal-containing feedstock 16 to press it to the substratum 40. Pulsed power current may then be passed through the elongated metal-containing feedstock 16 and the substratum 40 by being discharged from one of the electrodes 44 (e.g., cathode) and flow to the other of the electrodes 44 (e.g., anode). As the electric current is passed through the elongated metal-containing feedstock 16 and the substratum 40, heat is generated from resistance to pulsed current flow, resulting in joining through the formation of a spot weld, solid state join or wire bond to join the elongated metal-containing feedstock 16 and the substratum 40.

In some embodiments, the print head 12 may further include the force applicator 46. In other embodiments, the force applicator 46 may be a separate component from the print head 12. The force applicator 46 may function, for example, to apply a clamping force to the elongated metal-containing feedstock 16 to press it to the substratum 40. Any suitable device may be used for providing the force, including a bar, rod, magnet, hydraulic press, piston or plate. In some embodiments, the force applicator 46 comprises a clamping pin. Alternatively, the force applicator 46 may be incorporated as one or more of the electrodes 44 that pass current into the elongated metal-containing feedstock 16.

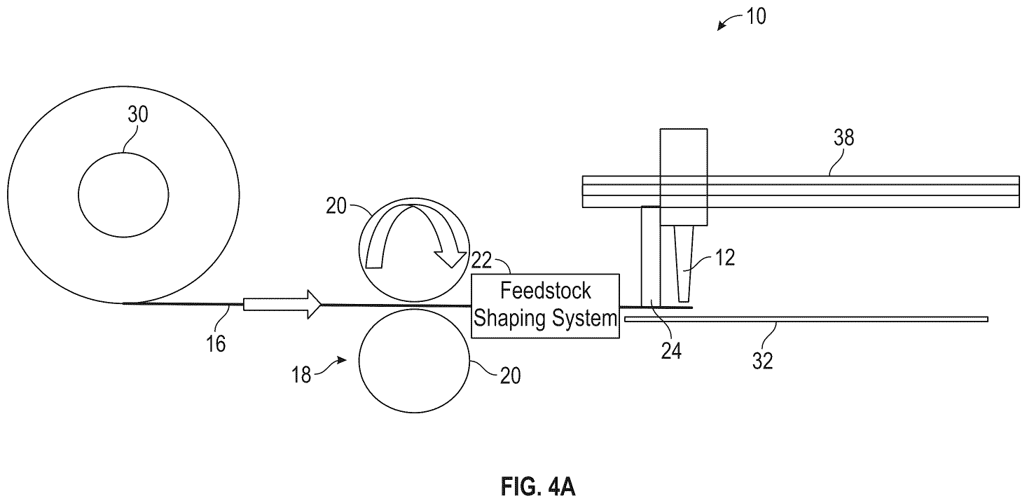

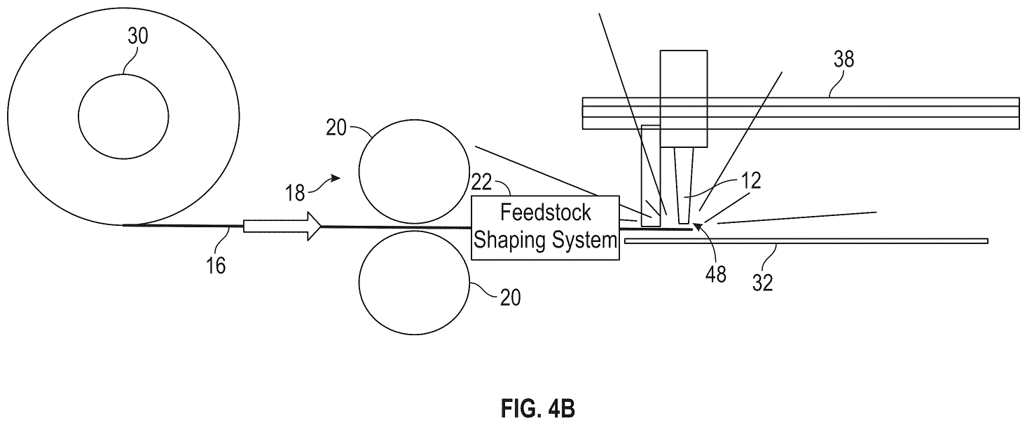

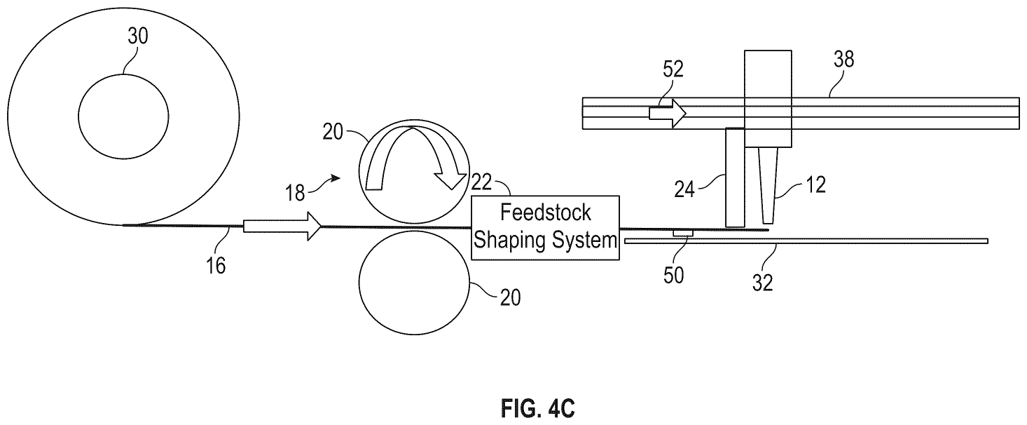

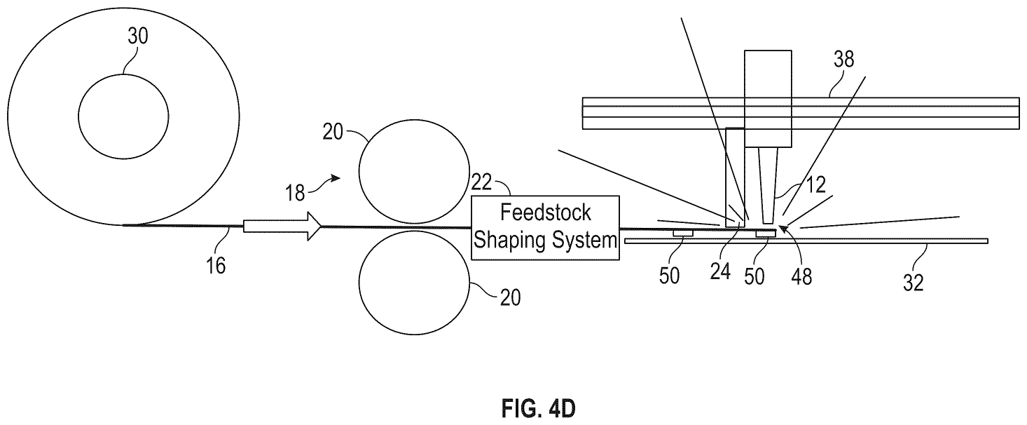

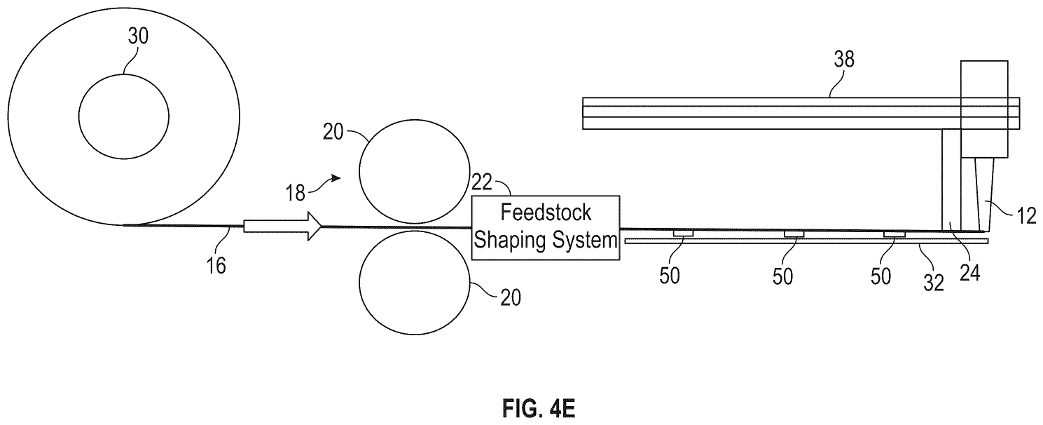

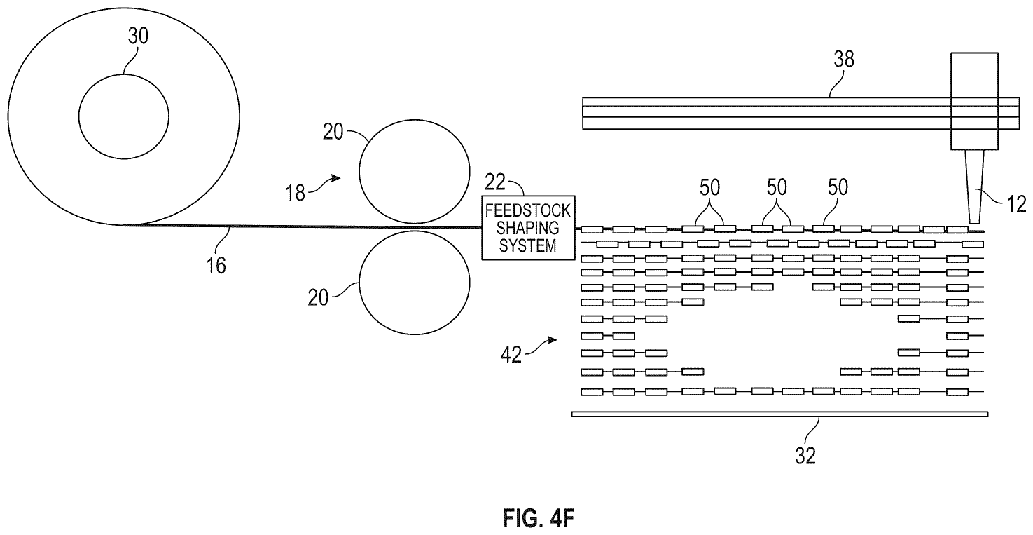

FIGS. 4A to 4F illustrate a process for additive manufacturing with the system 10 in accordance with one or more pulsed power embodiments. As illustrated in FIG. 4A, an elongated metal-containing feedstock 16 may be provided on spool 30. Feed drive mechanism 18 (e.g., feed rollers 20) may rotate to supply the elongated metal-containing feedstock 16 from the spool 30 to the print head 12. A wire straightener (e.g., wire straightener ** shown on FIG. 7) may be used to straighten the elongated metal-containing feedstock 16 as it leaves the spool 30, and a feedstock shaping system (feedstock shaping system can be used to shape the elongated metal-containing feedstock 16 in accordance with a digital model before it reaches the print head 12. FIG. 4B illustrates the print head 12 receiving power (e.g., pulsed power) from a power supply (e.g., pulsed power supply 26 shown on FIG. 1 or FIG. 7) such that pulsed electric current (e.g., a high power electrical pulse 48 is passed from the print head 12 through the elongated metal-containing feedstock 16 and the substratum (e.g., print bed 32) to generate heat from resistance to current flow. The print head 12 (or a separate force applicator) can also apply force to the elongated metal-containing feedstock 16 to press the elongated metal-containing feedstock 16 to the substratum. From the heat generated by the current pulse, a joint 50 (e.g., a spot weld, solid state joint, or wire bond) is formed between the elongated metal-containing feedstock 16 and the substratum as shown in FIG. 4C. Further, as illustrated in FIG. 4C, the print head 12 may be moved to another position of the elongated metal-containing feedstock 16 to join additional portions of the elongated metal-containing feedstock 16 to the substratum (e.g., in the direction shown by arrow 52). As shown on FIG. 4D, the print head 12 may receive additional power (e.g., pulsed power) from a power supply (e.g., shown on FIG. 1 or FIG. 7) such that pulsed electric current is passed from the print head 12 through the elongated metal-containing feedstock 16 and the substratum (e.g., print bed 32) to generate heat from resistance to current flow. From the heat, an additional joint 50 (e.g., spot weld, solid state join, or wire bond) is formed between the elongated metal-containing feedstock 16 and the substratum to join them at an additional location. This process can be repeated, as shown in FIG. 4E, to join additional portions of the elongated metal-containing feedstock 16 to the substratum, which is shown as a print bed 32 but can be another portion of the elongated metal-containing feedstock 16 in other embodiments. As shown on FIG. 4F, multiple layers of the elongated metal-containing feedstock 16 may be placed and joined to adjacent layers to form the assembled structure 42. The elongated metal-containing feedstock 16 may be shaped and cut with the feedstock shaping system 22 or cutter 24 in accordance with the digital model of the assembled structure 42. While the pulse induced spots welds, solid state joints or wire bonds are shown spaced in FIG. 4F, the spot welds, solid state joints or wire bonds for joining particular layers may overlap in accordance with example embodiments.

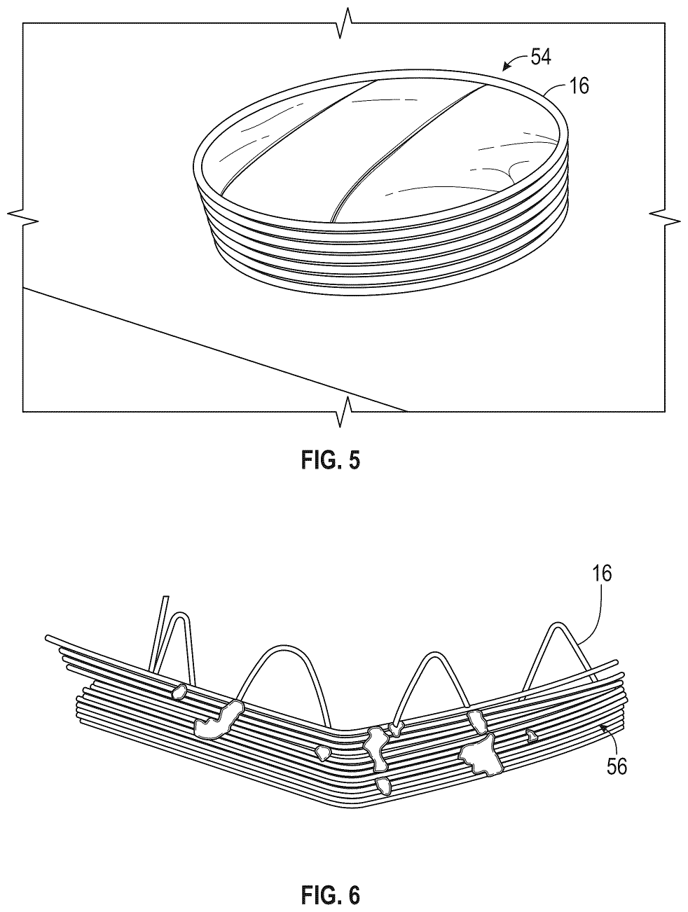

Example embodiments of the pulsed power additive manufacturing system and pulsed power methods may be used to assemble a wide variety of structures. FIG. 5 illustrates examples of multiple layers of a first assembled structure 54 formed by pulsed power additive manufacturing using a metal wire as the elongated metal-containing feedstock 16 in accordance with one or more embodiments of the present invention. The first assembled structure 54 of FIG. 5 is in the form of a steel ring with a water-tight geometry. The joint regions between each successive layer of the assembled structure are shown. FIG. 6 illustrates an example of a second assembled structure 56 formed from additive manufacturing using a metal wire as the elongated metal-containing feedstock 16 in accordance with one or more embodiments of the present invention. The second assembled structure 56 of FIG. 6 is in the form of a corner. The joint regions between each successive layer of the second assembled structure 56 are shown.

FIG. 7 illustrates a block diagram of a system 10 for additive manufacturing in accordance with pulsed power example embodiments. As illustrated, the block diagram includes a feed system 14 including elongated metal-containing feedstock 16 (not separately shown on FIG. 7), a wire straightener 58, a wire feed drive mechanism 60 (e.g., wire feed), and a feedstock shaping system 22 (e.g., wire bender). The system 10 also includes a pulsed power supply 26 that includes DC power source 62 and a spiral generator 64. The pulsed power supply 26 provides pulsed power to the print head 12 for formed an assembled structure 42 (e.g., part). The assembled structure 42 may be fabricated, for example, in an enclosure 66 with an inert atmosphere. The system 10 may further include a controller (e.g., controller 28 shown on FIG. 1), for example, in signal communication with the pulsed power supply 26, print head 12, and feed system 14.

The feed system 14 provides an elongated metal-containing feedstock (e.g., elongated metal-containing feedstock 16 on FIG. 1, such as a metal wire) to the print head 12. On FIG. 7, the wire feed drive mechanism 60 drives the elongated metal-containing feedstock from the spool 30 through a wire straightener 58 to feedstock shaping system 22 (e.g., wire bender). The feedstock shaping system 22 shapes the elongated metal-containing feedstock in accordance with a digital model, for example. As illustrated, a strain gauge 68 may be provided between the wire feed drive mechanism 60 and the feedstock shaping system 22 (e.g., wire bender). The strain gauge 68 may monitor, for example, feedstock tension. The elongated metal-containing feedstock 16 may be fed from the feedstock shaping system 22 to the print head 12.

As illustrated in FIG. 7, the pulsed power supply 26 provides pulsed power supplied by a DC or AC power source to the print head 12. The pulsed power supply 26 may output DC power to a rectifier with an optional filter (e.g., rectifier/filter 70) to provide more steady power. The power from the rectifier/filter 70 may be sent to at least one switch 72. The at least one switch 72 may provide power to additional components of the system 10. In the embodiments illustrated in FIG. 7, the at least one switch 72 provide power to the wire feed drive mechanism 60, the spiral generator 64, and a print bed heater 74. While the at least one switch 72 is shown as separate components, a single switch may be used to provide an electrical connection from the DC output power to these components. Before the DC power from the DC power source 62 is received by the spiral generator 64, the power may go through a transformer 76 for increasing or reducing voltage and then through a diode (e.g., high voltage diode 78) with breakdown strengths of up to about 100 kV before being fed to the spiral generator 64. The power from the high voltage diode 78 may be monitored with a voltage sensor 80, such as a high voltage sensor being able to measure up to about 600 kV. The spiral generator 64 may be a vector inversion spiral generator, which is an electric pulse compression and voltage magnification device to shape slower, lower voltage pulses to narrower, higher voltage pulses. The spiral generator 64 may include a section acting as a capacitor, such as a rolled-up strip transmission line with an additional insulating layer between turns, and the insulating layer may be comprised of a high permittivity dielectric. The DC power from the DC power supply 62 charges the spiral generator 64 which is shorted at periodic intervals to create a pulsed output with a desired amplitude. The discharge time can be very short, in the range of nanoseconds (about 1 to about 500 nanoseconds). A first current clamp 82 (e.g., a Rogowski coil) may be used to measure the current of the electrical pulses being delivered to the print head 12. Thyristor 84 or triac switches may be used to control the discharge time and pulse rate of the internal power circuit, such as a spiral generator.

The pulsed power supply 26 may also provide power to a feed capacitor 86, which may be from the DC power source 62. The feed capacitor 86 provides additional energy to allow tailoring for total output energy and power. A second current clamp 88 (e.g., a Rogowski coil) may be used to measure the current of the electrical power being delivered from the feed capacitor to the print head 12. A voltage sensor 90 may also be used to measure the voltage of the electrical power being delivered from the feed capacitor 86 to the print head 12.

The print head 12 passes electric current pulses through the elongated metal-containing feedstock and a substratum (e.g., elongated metal-containing feedstock 16 on FIG. 1 and substratum 40 on FIG. 2) to generate heat from resistance to pulse current flow. A force applicator (e.g., force applicator 46 shown on FIG. 3) may further be included in the system 10 to press the elongated metal-containing feedstock 16 the substratum, which may be, for example, a print bed 32 or a previously placed portion of the elongated metal-containing feedstock. By passing electric current through the elongated metal-containing feedstock and the substratum, the two may be joined to one another. For example, spot welds, solid state joints, or wire bonds may be formed to join the elongated metal-containing feedstock and the substratum. This process may be repeated for additional portions of the elongated metal-containing feedstock to join them together and produce the assembled structure 42.

The assembled structure 42 may be supported on a print bed 32. The print bed 32 may be heated or cooled by a print bed heater/cooler (e.g., print bed heater 74) to tailor the microstructure and cooling rate of the additively manufactured assembled structure 42. Power may be provided to the print bed heater/cooler from the appropriate power source by way of at least one switch 72. A first temperature sensor 92 may be used to monitor the temperature of the part. A camera 94 may also be used to monitor assembly of the assembled structure 42.

The print bed 32 may be disposed in an enclosure 66. In some embodiments, the enclosure 66 may have an inert environment. A vacuum pump 96 may be used to evacuate the atmosphere in the enclosure while an inert gas 98 may then be supplied to the enclosure. Examples of suitable inert gases include argon, helium, krypton, xenon, nitrogen, carbon dioxide and neon. An appropriate power source (e.g., power source 100) may be used to power the vacuum pump 96. The power source 100 for powering the pump may be any suitable power source, including an AC power source. Pressure and temperature sensors (e.g., pressure sensor 102 and second temperature sensor 104) may be used to monitor the environment in the enclosure. An oxygen sensor 106 may also be used to monitor the environment in the enclosure 66. A photocell 108 may also be used to monitor the print head 12 in the enclosure 66.

Accordingly, the present disclosure may provide various system and methods for additive manufacturing that join an elongated metal-containing feedstock to a substratum through a solid-state joining process that uses high power, high voltage, short duration energy pulses to join the metal feedstock. The methods and systems may include any of the various features disclosed herein, including one or more of the following embodiments.

Embodiment 1. A system for additive manufacturing comprising: a feedstock shaping system for shaping an elongated metal-containing feedstock; a force applicator for applying force to the elongated metal-containing feedstock; a print head for passing a pulsed electric current through the elongated metal-containing feedstock and a substratum; and a power supply associated with the print head for sending pulsed power to the print head.

Embodiment 2. The system of Embodiment 1, wherein the elongated metal-containing feedstock comprises a wire having cross-sectional areas of about 2,500 square millimeters or less.

Embodiment 3. The system of Embodiment 1 or 2, wherein the elongated metal-containing feedstock comprises a wire with a circular, square, hexagonal, ribbon, half-round, triangle or rectangular or other geometric-shaped cross-section which may include secondary features such as guide grooves, divots, locating protrusions or depressions.

Embodiment 4. The system of any preceding Embodiment, wherein the force applicator comprises at least one element selected from the group consisting of an electrode, clamping pin, plate, rod, magnet, hydraulic press, piston, and a cam on a distal pin that engages the elongated metal-containing feedstock.

Embodiment 5. The system of any preceding Embodiment, wherein the print head comprises one or more electrodes.

Embodiment 6. The system of any preceding Embodiment, wherein the print head is mounted on a motion control platform.

Embodiment 7. The system of any preceding Embodiment, wherein the substratum is mounted on a motion control platform.

Embodiment 8. The system of any preceding Embodiment, wherein the print head is mounted on a robotic arm, linear element, or rotary element.

Embodiment 9. The system of any preceding Embodiment, wherein the substratum is mounted on a robotic arm, linear element, or rotary element.

Embodiment 10. The system of any preceding Embodiment, wherein the print head and substratum are mounted on independent motion control platforms.

Embodiment 11. The system of any preceding Embodiment, where the power supply is configured to provide energy pulses in a range of about 1 millijoule to about 1 megajoule at a frequency of about 1 millihertz to about 1 megahertz.

Embodiment 12. The system of any preceding Embodiment, where the power supply is configured to provide energy pulses in a range of about 1 nanosecond to about 1 second at a frequency of about 1 millihertz to about 1 megahertz.

Embodiment 13. The system of any preceding Embodiment, wherein the power supply comprises at least one element selected from the group consisting of a linear transformer driver, a Marx generator, capacitive discharge, inductive discharge, a tesla coil, a Blumlein pulse forming network, a pulse transformer, a transverse electromagnetic mode cell, a magnetic pulse compression, a vector inversion spiral generator, an explosively driven pulsed power generator, a compact magnetic pulse compression generator, a capacitor bank, and a transmission line transformer.

Embodiment 14. The system of any preceding Embodiment, where the power supply comprises a DC output power supply connected to a feed capacitor connected to a vector inversion spiral generator and shorting switch.

Embodiment 15. The system of claim 14, wherein the vector inversion spiral generator comprises a rolled strip transmission line with one or more insulating layers between turns.

Embodiment 16. The system of claim 14, wherein the vector inversion spiral generator comprises a rolled strip transmission line with one or more insulating layers between turns comprised of a high relative permittivity dielectric.

Embodiment 17. The system of any preceding Embodiment, further comprising a wire spool, a wire straightener for straightening the elongated metal-containing feedstock from the wire spool, and opposing rollers for feeding the elongated metal-containing feedstock from the wire spool to the feedstock shaping system.

Embodiment 18. The system of any preceding Embodiment, further comprising a wire cutter associated with the feedstock shaping system for cutting the elongated metal-containing feedstock.

Embodiment 19. The system of any preceding Embodiment, further comprising a print bed heater for heating for heating a part being assembled, or a print bed cooler for cooling a part being assembled.

Embodiment 20. The system of any preceding Embodiment, further comprising a controller that provides at least position instructions to the motion control platform for guiding a print head or substratum to build an assembled structure from the elongated metal-containing and shaping instruction to the feedstock shaping system for shaping the elongated metal-containing feedstock in accordance with a digital model of the assembled structure.

Embodiment 21. The system of claim 20, wherein the controller further provides at least instructions to the power supply to provide energy pulses in a range of about 1 millijoule to about 1 megajoule at a frequency of about 1 millihertz to about 1 megahertz.

Embodiment 22. The system of any preceding Embodiment, further comprising an enclosure with an inert environment for assembly of an assembled structure, wherein the print head is at least partially disposed in the enclosure with electrodes of the print head in the enclosure.

Embodiment 23. The system of cany preceding Embodiment, wherein the elongated metal-containing feedstock is selected from the group consisting of a metal, a metal-ceramic, and an additional metal-containing material.

Embodiment 24. A method for additive manufacturing comprising: feeding an elongated metal-containing feedstock to a print head; shaping the elongated metal-containing feedstock in accordance with a digital model of an assembled structure; applying pressure to press the elongated metal-containing feedstock to a substratum; sending energy to the print head such that an electric current passes between the elongated metal-containing feedstock and the substratum; and joining the elongated metal-containing feedstock and the substratum.

Embodiment 25. The method of Embodiment 24, wherein the feeding of the elongated metal-containing feedstock comprises passing the elongated metal-containing feedstock through opposing rollers that hold the elongated feedstock while also moving the elongated metal-containing feedstock to the print head.

Embodiment 26. The method of Embodiment 24 or 25, wherein the elongated metal-containing feedstock and the substratum are each wires having cross-sectional areas of about 2,500 square millimeters or less.

Embodiment 27. The method of any one of Embodiments 24 to 26, wherein the elongated metal-containing feedstock is a wire with a circular, square, hexagonal, ribbon, half-round, triangle or rectangular or other geometric-shaped cross-section which may include secondary features such as guide grooves, divots, locating protrusions or depressions.

Embodiment 28. The method of any one of Embodiments 24 to 27, wherein the shaping the elongated metal-containing feedstock comprises bending or straightening the elongated metal-containing feedstock.

Embodiment 29. The method of any one of Embodiments 24 to 28, wherein the sending the energy comprises sending energy in a range of about 1 nanosecond to about 1 second at a frequency of about 1 millihertz to about 1 megahertz.

Embodiment 30. The method of any one of Embodiments 24 to 29, wherein the sending the energy comprises pulsing energy from a spiral generator that repeatedly charges and then is shorted to release energy pulses.

Embodiment 31. The method of any one of Embodiments 24 to 30, wherein the joining is performed in a space environment.

Embodiment 32. The method of any one of Embodiments 24 to 30, wherein the joining is performed is formed on the moon.

Embodiment 33. The method of any one of Embodiments 24 to 32, wherein the joining is performed in an inert environment.

Embodiment 34. The method of any one of Embodiments 24 to 33, further comprising repeating the steps of shaping, applying, sending, and forming to thereby form one or more additional spot welds, solid state joints, or wire bonds between the elongated metal-containing feedstock and the substratum.

Embodiment 35. The method of any one of Embodiments 24 to 34, wherein the joining the elongated metal-containing feedstock and the substratum comprises forming a spot weld, solid state joint, or wire bond.

Embodiment 36. The method of any one of Embodiments 24 to 35, wherein the joining is from heat generated from the electric current.

Embodiment 37. The method of any one of Embodiments 24 to 36, wherein the wherein the electric current generates plasma that at least partially removes oxide from the elongated metal-containing feedstock.

Embodiment 38. A method for additive manufacturing comprising: cutting the elongated metal-containing feedstock to form a layer of elongated metal-containing feedstock; feeding an additional portion of the elongated metal-containing feedstock to a print head; shaping the additional portion of the elongated metal-containing feedstock in accordance with a digital model of an assembled structure; applying pressure to press the additional portion of the elongated metal-containing feedstock to the layer of elongated feedstock that was cut; sending additional power to the print head such that electric current passes between the additional portion of the elongated metal-containing feedstock and the layer of the elongated metal-containing feedstock to generate heat from resistance to current flow; and forming a spot weld, solid state joint, or wire bond from heat generated from the electric current to thereby join the additional portion of the elongated metal-containing feedstock and the layer of the elongated metal-containing feedstock.

Embodiment 39. The method of claim 38, further comprising repeating the steps of shaping, applying, sending, and forming for the additional portion of the elongated metal-containing feedstock to thereby form one or more additional spot welds, solid state joints, or wire bonds between the elongated feedstock and the substratum and then forming additional layers of the elongated metal-containing feedstock that are spot welded, solid state joined, or wire bonded to one another with the print head to form the assembled structure.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Various advantages of the present disclosure have been described herein, but embodiments may provide some, all, or none of such advantages, or may provide other advantages.

What is claimed is:

1. A system for additive manufacturing comprising:
a feedstock shaping system for shaping an elongated metal-containing feedstock;
a force applicator for applying force to the elongated metal-containing feedstock;
a print head for passing a pulsed electric current through the elongated metal-containing feedstock and a substratum; and
a power supply associated with the print head for sending pulsed power to the print head.

2. The system of claim 1, wherein the elongated metal-containing feedstock comprises a wire having cross-sectional areas of about 2,500 square millimeters or less.

3. The system of claim 1, wherein the force applicator comprises at least one element selected from the group consisting of an electrode, clamping pin, plate, rod, magnet, hydraulic press, piston, and a cam on a distal pin that engages the elongated metal-containing feedstock.

4. The system of claim 1, wherein the print head comprises one or more electrodes.

5. The system of claim 1, wherein at least one of the print head and/or the substratum is mounted on a motion control platform.

6. The system of claim 1, where the power supply is a pulsed power supply for supplying energy pulses in a range of about 1 nanosecond to about 1 second at a frequency of about 1 millihertz to about 1 megahertz.

7. The system of claim 1, wherein the power supply comprises at least one element selected from the group consisting of a linear transformer driver, a Marx generator, capacitive discharge, inductive discharge, a tesla coil, a Blumlein pulse forming network, a pulse transformer, a transverse electromagnetic mode cell, a magnetic pulse compression, a vector inversion spiral generator, an explosively driven pulsed power generator, a compact magnetic pulse compression generator, a capacitor bank, and a transmission line transformer.

8. The system of claim 1, where the power supply comprises a DC output power supply connected to a feed capacitor connected to a vector inversion spiral generator and shorting switch.

9. The system of claim 8, wherein the vector inversion spiral generator comprises a rolled strip transmission line with one or more insulating layers between turns.

10. The system of claim 1, further comprising a wire spool, a wire straightener for straightening the elongated metal-containing feedstock from the wire spool, and opposing rollers for feeding the elongated metal-containing feedstock from the wire spool to the feedstock shaping system.

11. The system of claim 1, further comprising a controller that provides at least position instructions to a motion control platform for guiding a print head or substratum to build an assembled structure from the elongated metal-containing and shaping instruction to the feedstock shaping system for shaping the elongated metal-containing feedstock in accordance with a digital model of the assembly structure.

12. The system of claim 11, wherein the controller further provides at least instructions to the power supply to provide energy pulses in a range of about 1 millijoule to about 1 megajoule at a frequency of about 1 millihertz to about 1 megahertz.

13. The system of claim 1, further comprising an enclosure with an inert environment for assembly of an assembled structure, wherein the print head is at least partially disposed in the enclosure with electrodes of the print head in the enclosure.

14. A method for additive manufacturing comprising:
feeding an elongated metal-containing feedstock to a print head;
shaping the elongated metal-containing feedstock in accordance with a digital model of an assembled structure;
applying pressure to press the elongated metal-containing feedstock to a substratum;
sending energy to the print head such that an electric current passes between the elongated metal-containing feedstock and the substratum; and
joining the elongated metal-containing feedstock and the substratum.

15. The method of claim 14, wherein the feeding of the elongated metal-containing feedstock comprises passing the elongated metal-containing feedstock through opposing rollers that hold the elongated metal-containing feedstock while also moving the elongated metal-containing feedstock to the print head.

16. The method of claim 14, wherein the sending the energy comprises sending energy in a range of about 1 nanosecond to about 1 second at a frequency of about 1 millihertz to about 1 megahertz, and wherein the sending the energy comprises pulsing energy from a spiral generator that repeatedly charges and then is shorted to release energy pulses.

17. The method of claim 14, wherein the joining is performed in a space environment.

18. The method of claim 14, wherein the joining the elongated metal-containing feedstock and the substratum comprises forming a spot weld, solid state joint, or wire bond.

19. The method of claim 14, wherein the joining is from heat generated from the electric current.

20. The method of claim 14, wherein the wherein the electric current generates plasma that at least partially removes oxide from the elongated metal-containing feedstock.
